(19) United States
(12) Patent Application Publication
(10) Pub. No.: US 2026/0062055 A1
(43) Pub. Date: Mar. 5, 2026

(54) VEHICLE SKELETON STRUCTURE

(71) Applicant: TOYOTA JIDOSHA KABUSHIKI KAISHA, Toyota-shi (JP)

(72) Inventor: Katsuichiro HIRAKAWA, Toyota-shi (JP)

(73) Assignee: TOYOTA JIDOSHA KABUSHIKI KAISHA, Toyota-shi (JP)

(21) Appl. No.: 19/172,782

(22) Filed: Apr. 8, 2025

(30) Foreign Application Priority Data
Aug. 29, 2024 (JP) 2024-148032

(51) Int. Cl. B62D 21/11; B60G 7/00; B62D 21/02

(52) U.S. Cl. CPC B62D 21/11; B60G 7/001; B62D 21/02

(57) ABSTRACT

In the vehicle skeleton structure, a pair of left and right suspension arms are respectively attached to a pair of left and right side members. The pair of left and right side members are skeletal members respectively extending in the vehicle front-rear direction at both end portions in the vehicle width direction in the vehicle front portion or the vehicle rear portion. This eliminates the need for a suspension member, thereby realizing a so-called suspension member-less body, which makes it possible to reduce the number of components. As a result, the assembly process can be reduced.

### CROSS-REFERENCE TO RELATED APPLICATION

This application claims priority to Japanese Patent Application No. 2024-148032 filed on Aug. 29, 2024, incorporated herein by reference in its entirety.

### BACKGROUND

### 1. Technical Field

The present disclosure relates to a vehicle skeleton structure.

### 2. Description of Related Art

Japanese Unexamined Patent Application Publication No. 2021-052511 (JP 2021-052511 A), for example, discloses a technology related to an electrified vehicle. In this related art, a drive motor for the electrified vehicle is mounted on a suspension member.

### SUMMARY

At the time of assembling the vehicle, the suspension member is attached to a so-called white body in a state in which the drive motor and a suspension arm such as an upper arm and a lower arm are assembled. The suspension arm has a large number of parts, and accordingly involves a large number of work processes.

The present disclosure provides a vehicle skeleton structure capable of reducing the number of parts and assembly processes.

A first aspect of the present disclosure provides a vehicle skeleton structure, in which a pair of right and left suspension arms is respectively attached to a pair of right and left side members as skeleton members that extend in a vehicle front-rear direction at both end portions in a vehicle width direction at a vehicle front portion or a vehicle rear portion.

In the vehicle skeleton structure according to the first aspect, a pair of right and left side members as skeleton members extends in the vehicle front-rear direction at both end portions in the vehicle width direction at the vehicle front portion or the vehicle rear portion. A pair of right and left suspension arms is respectively attached to the right and left side members.

In general, a suspension arm is attached to a suspension member, and the suspension member is formed as a separate member from a side member as a skeleton member.

On the contrary, in the present disclosure, the suspension arm is attached to the side member (body side) at the vehicle front portion or the vehicle rear portion, and therefore no suspension member is required. That is, in the present disclosure, a so-called suspension member-less body can be achieved, whereby the number of parts can be reduced, the weight of the vehicle can be reduced, and the fuel efficiency of the vehicle can be improved.

Further, as a comparative example, in a vehicle provided with a suspension member, the suspension member is attached to a side member at the vehicle front portion or the vehicle rear portion. It is necessary to provide a gap between the side member and the suspension member such that the side member and the suspension member do not interfere with each other.

On the contrary, in the present disclosure, there is no suspension member. Therefore, it is not necessary to provide a gap for avoiding interference with the body side, and it is possible to accordingly increase the dimension in the vehicle width direction and the vehicle up-down direction of the side member as a skeleton member. As a result, the rigidity of the side member can be improved, and the steering stability during travel of the vehicle can be improved.

Further, by improving the rigidity of the side member, it is possible to suppress the bending deformation of the side member at the time of a front collision of the vehicle (hereinafter, simply referred to as “at the time of a front collision”) or at the time of a rear collision of the vehicle (hereinafter, simply referred to as “at the time of a rear collision”). Here, the “front collision” is a concept including not only a full overlap front collision but also an offset collision, an oblique collision, and a small overlap collision. The same applies to the “rear collision”as the “front collision”.

Further, in the present disclosure, since there is no suspension member, it is not necessary to provide a gap for avoiding interference with the body side, and accordingly, it is possible to sufficiently secure a space for mounting a drive motor or the like, improving the assembly workability.

Further, in the present disclosure, since there is no suspension member, it is not necessary to attach the suspension member to the side member, and accordingly the number of assembly processes is reduced.

Furthermore, in general, a cushioning member is provided between a suspension arm and a suspension member and between a suspension member and a side member (body) (so-called double vibration isolation). On the contrary, in the present disclosure, the suspension member is integrated with the body, and therefore no cushioning member is required between the suspension member and the body, resulting in so-called single vibration isolation and accordingly reducing the number of parts.

A second aspect provides the vehicle skeleton structure according to the first aspect, in which a first cross member and a second cross member provided on a rear side in the vehicle front-rear direction with respect to the first cross member are bridged along the vehicle width direction between the right and left side members, a front side in the vehicle front-rear direction of a drive motor that drives a vehicle being attached to the first cross member, and a rear side in the vehicle front-rear direction of the drive motor being attached to the second cross member.

In the vehicle skeleton structure according to the second aspect, a first cross member and a second cross member are bridged along the vehicle width direction between the right and left side members, and the second cross member is disposed on the rear side in the vehicle front-rear direction with respect to the first cross member.

The front side in the vehicle front-rear direction of a drive motor is attached to the first cross member, and the rear side in the vehicle front-rear direction of the drive motor is attached to the second cross member. That is, the drive motor is mounted on the right and left side members via the first cross member and the second cross member.

In the present disclosure, the workability is improved since it is only necessary to mount the drive motor on the cross member provided on the side member, as compared with the case where the drive motor is mounted on the suspension member and the suspension member is attached to the side member.

A third aspect provides the vehicle skeleton structure according to the first aspect, in which the suspension arms are each configured to include: a lower arm connected to a wheel; and an upper arm connected to the wheel and disposed on a vehicle upper side of the lower arm.

In the vehicle skeleton structure according to the third aspect, the suspension arms are each configured to include a lower arm and an upper arm connected to a wheel, and the upper arm is disposed on the vehicle upper side of the lower arm. The lower arm and the upper arm are disposed on the upper and lower sides of the vehicle.

As a comparative example, when a lower arm and an upper arm are connected to a suspension member, the upper arm is connected to the upper side of the suspension member. Since a side member is disposed on the upper side of the suspension member, it is necessary to avoid interference between the upper arm and the side member, and it may be difficult to form the upper arm in a straight shape.

On the contrary, in the present disclosure, the upper arm is connected to the side member, and therefore the upper arm can be formed in a straight shape, and the rigidity of the upper arm itself can be improved.

A fourth aspect provides the vehicle skeleton structure according to the first aspect, further including a pair of right and left rockers that extend in the vehicle front-rear direction at both end portions in the vehicle width direction of a floor panel, in which a pair of right and left coupling portions is provided at one end portion in the vehicle front-rear direction of the right and left side members, the right and left coupling portions being respectively coupled to one end portion in the vehicle front-rear direction of the right and left rockers in an overlapping state from an outer side in the vehicle width direction.

The vehicle skeleton structure according to the fourth aspect includes a pair of right and left rockers. The right and left rockers extend in the vehicle front-rear direction at both end portions in the vehicle width direction of the floor panel. Meanwhile, a pair of right and left coupling portions is provided at one end portion of the right and left side members, respectively. One end portion in the vehicle front-rear direction of the right and left side members is coupled to one end portion in the vehicle front-rear direction of the right and left rockers via the right and left coupling portions in an overlapping state from the outer side in the vehicle width direction.

Here, a battery is mounted on a vehicle center portion constituted by the floor panel and the right and left rockers, and the vehicle center portion has high rigidity. That is, one end portion in the vehicle front-rear direction of the right and left side members is coupled to one end portion in the vehicle front-rear direction of the vehicle center portion having high rigidity in an overlapping state from the outer side in the vehicle width direction. Thus, according to the present disclosure, it is possible to improve the rigidity of the side member with respect to the yaw direction, and it is possible to improve the steering stability during travel of the vehicle.

As described above, the vehicle skeleton structure according to the present disclosure makes it possible to reduce the number of parts and assembly processes.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a center portion and a rear portion of a vehicle to which a vehicle skeleton structure according to the present embodiment is applied as viewed from a left obliquely upper side;

FIG. 2A is a schematic plan view of the left side of the vehicle showing the main part of FIG. 1;

FIG. 2B is a schematic side view of the left side of the vehicle showing the main part of FIG. 1;

FIG. 3A is a schematic view showing a vibration damping device according to a comparative embodiment;

FIG. 3B is a schematic view illustrating a vibration damping structure according to a vehicle skeleton structure according to the present embodiment;

FIG. 4 is a perspective view corresponding to FIG. 1 as a comparative example;

FIG. 5A is a schematic plan view corresponding to FIG. 2A as a comparative example; and

FIG. 5B is a schematic side view corresponding to FIG. 2B as a comparative example.

### DETAILED DESCRIPTION OF EMBODIMENTS

Hereinafter, a vehicle skeleton structure according to an embodiment of the present disclosure will be described with reference to the drawings. The arrow FR, the arrow UP, and the arrow RH shown in the drawings indicate the front side, the upper side, and the right side in the left-right direction (widthwise direction), respectively. In addition, in the following description, when the front, rear, up, down, and left and right directions are used without special mention, the front and rear directions in the vehicle front-rear direction, the up and down directions in the vehicle up-down direction, and the left and right directions (width directions) in the vehicle left-right direction are respectively indicated.

### Configuration of Vehicle Skeleton Structure

First, the configuration of the vehicle skeleton structure according to the present embodiment will be described.

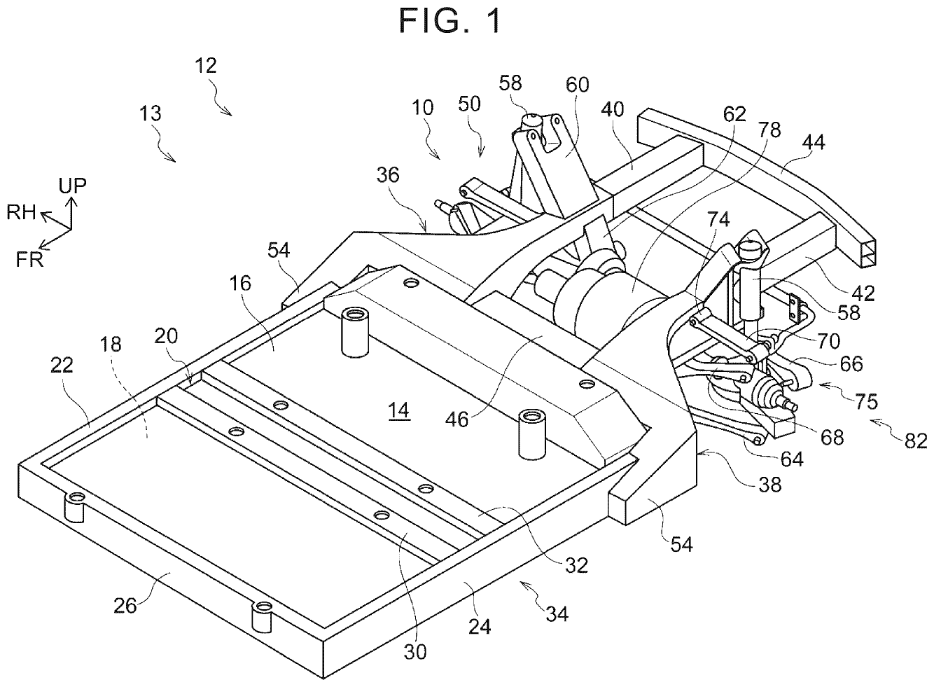

FIG. 1 is a perspective view of a rear portion 13 of a vehicle 12 to which the vehicle skeleton structure 10 according to the present embodiment is applied as viewed from a left obliquely front side and an upper side. The vehicle 12 is an electrified vehicle provided with a battery 18 on the vehicle lower side of the floor panel 16 constituting the floor portion of the vehicle cabin 14. The battery 18 is housed in a battery case 20 having a substantially rectangular shape in a plan view. In the present embodiment, for example, the cover constituting the upper portion of the battery case 20 constitutes the floor panel 16.

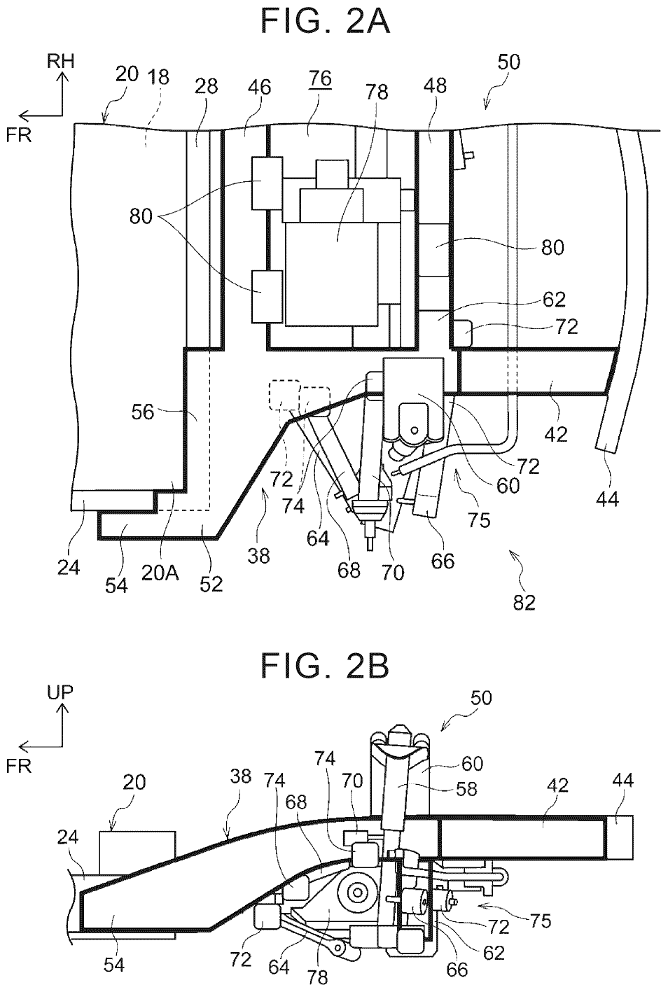

A pair of left and right rockers 22 and 24 as skeletal members extend along the vehicle front-rear direction at both end portions of the floor panel 16 in the vehicle width direction. The rockers 22 and 24 have, for example, a substantially rectangular frame shape in cross section when cut along the vehicle width direction, and the front cross members 26 are bridged along the vehicle width direction at the front ends of the rockers 22 and 24. Further, a rear cross member 28 (see FIG. 2A) is bridged along the vehicle-width direction at the rear end of the rockers 22 and 24.

Further, the center cross members 30 and 32 are bridged along the vehicle width direction in a state where they are arranged in the vehicle front-rear direction at the upper end portion of the substantially central portion of the rockers 22 and 24 in the vehicle front-rear direction. In the present embodiment, the battery case 20 is attached to the rockers 22 and 24, the front cross member 26, the rear cross member 28, and the center cross members 30 and 32 as the skeleton members. A module including the rockers 22 and 24, the front cross member 26, the rear cross member 28, and the battery case 20 is referred to as a so-called center module (vehicle center portion) 34.

A pair of left and right rear side members 36 and 38 extend along the vehicle front-rear direction on the vehicle rear side of the pair of left and right rockers 22 and 24. The rear end portions of the rear side members 36 and 38 are disposed on the vehicle upper side relative to the front end portion, and the rear side members 36 and 38 are formed to be substantially inclined upward toward the vehicle rear side as a whole.

A pair of left and right crash boxes 40 and 42, which are cushioning members, are respectively extended along the vehicle front-rear direction on the vehicle rear sides of the pair of left and right rear side members 36 and 38. The rear bumper 44 extends along the vehicle width direction with respect to the rear ends of the crash boxes 40 and 42.

### Rear Side Member

Here, the rear side members 36 and 38 will be described.

The rear side member 36 and the rear side member 38 are connected by a cross member (first cross member) 46 and a cross member (second cross member) 48, which will be described later, as shown in FIG. 2A. The rear side member 36 and the rear side member 38 have a substantially rectangular shape in plan view. The rear side member 36 and the rear side member 38 are integrally molded by casting using an aluminum alloy, a magnesium alloy, or the like as a material (so-called rear body 50).

Since the configurations of the rear side member 36 and the rear side member 38 are substantially the same, the description of the rear side members 36 and 38 is made with respect to the rear side member 38 on behalf of both, and the same reference numerals are used for the configurations common to both.

An inner surface side of the rear side member 38 in the vehicle width direction is formed along the vehicle front-rear direction. On the other hand, the outer surface side of the rear side member 38 in the vehicle width direction has a shape that expands in an arc shape with a convex front side toward the outside in the vehicle width direction toward the vehicle front side. That is, the width of the rear side member 38 gradually increases toward the outside in the vehicle width direction as it goes toward the vehicle front side.

The front portion 52 of the rear side member 38 has a substantially inverted L-shape in plan view, and is configured to be able to abut against the corner portion 20A of the rear end of the battery case 20. The front portion 52 of the rear side member 38 includes a coupling portion 54 disposed outside the battery case 20 in the vehicle width direction, and a coupling portion 56 disposed on the vehicle rear side of the battery case 20. The coupling portion 56 can be placed on the rear cross member 28.

Further, the coupling portion 54 is coupled to the rear end portion of the rocker 24 in a state of being overlapped from the outside in the vehicle width direction. For example, since the rocker 24 has a substantially rectangular frame shape in cross section when cut along the vehicle width direction, the coupling portion 54 is provided with an insertion portion (not shown) that is inserted into the rocker 24. The insertion portion is inserted into the rocker 24 in a state in which the coupling portion 56 is placed on the rear cross member 28. The rear side members 38 are coupled to the rocker 24 and the rear cross member 28 by bolts, welding, or the like at the coupling portions 54 and 56.

Here, as shown in FIGS. 1 and 2A, a cross member 46 as a first cross member is bridged along the vehicle widthwise direction at a substantially central portion in the vehicle front-rear direction on the inner surface of the rear side members 36 and 38. In the present embodiment, the cross member 46 is disposed on the vehicle rear side of the rear cross member 28 constituting a part of the center module 34.

On the other hand, as shown in FIGS. 1, 2A, and 2B, a suspension tower 60 that supports an upper end portion of the shock absorber 58 is erected at a rear end portion of the rear side member 38. On the lower side of the suspension tower 60, an inclined portion 62 including an inner surface of the rear side member 38 and inclined toward the inside in the vehicle width direction toward the lower side is suspended. At the lower end of the inclined portion 62, a cross member 48 serving as a second cross member is bridged along the vehicle width direction.

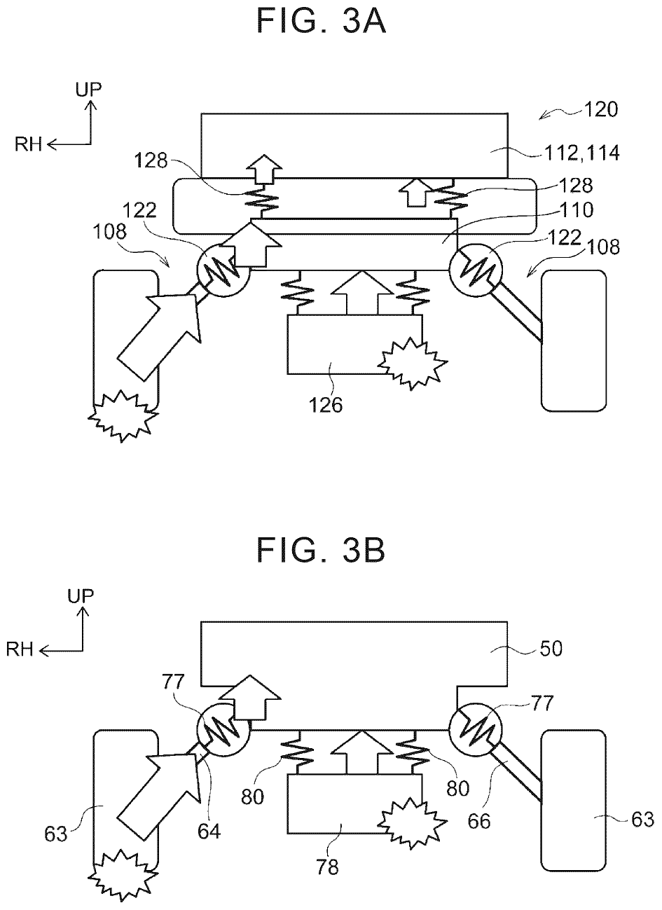

Further, lower arms (suspension arms) 64 and 66 and upper arms (suspension arms) 68 and 70 are attached to the rear side member 38, respectively, which are connected to wheels 63 (refer to FIG. 3B) and correspond to changes in the road surface. The lower arms 64 and 66 are attached to the lower side of the rear side member 38 (connecting portion 72), and the upper arms 68 and 70 are attached to the rear side member 38 on the upper side (connecting portion 74).

Further, in the present embodiment, the drive motor 78 can be disposed in the space portion 76 surrounded by the rear side members 36 and 38 and the cross members 46 and 48. The drive motor 78 is mounted to the cross members 46, 48 via a motor mount 80 with respect to the cross members 46, 48.

A configuration in which the drive motor 78, the lower arms 64 and 66, and the upper arms 68 and 70 are attached to the rear body 50 is referred to as a so-called rear module 82.

### Operation and Effect of Vehicle Skeleton Structure

Next, the operation and effects of the vehicle skeleton structure according to the present embodiment will be described.

In the present embodiment, as shown in FIG. 1, the lower arms 64 and 66 and the upper arms 68 and 70 are attached to the rear side members 36 and 38 as skeletal members.

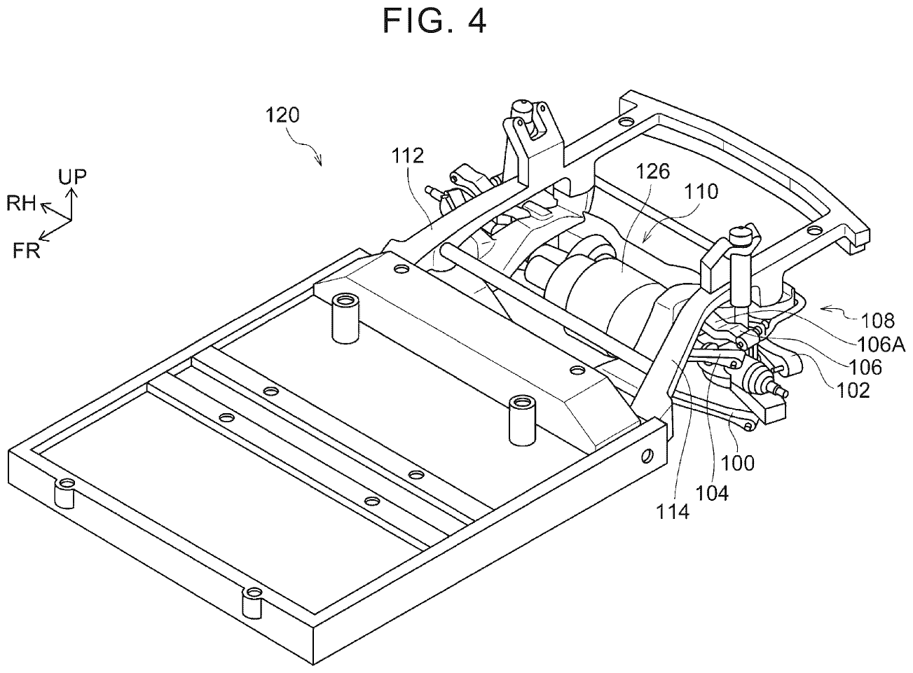

As a comparative example, as shown in FIG. 4, the suspension arm 108 including the lower arms 100 and 102 and the upper arms 104 and 106 is attached to the suspension member 110. The suspension member 110 is formed as a separate member from the rear side members 112 and 114.

In contrast, as shown in FIG. 1, in the present embodiment, the suspension arm 75 including the lower arms 64 and 66 and the upper arms 68 and 70 is attached to the rear side members 36 and 38. This eliminates the need for a suspension member.

That is, in the present embodiment, a so-called suspension member-less body can be realized, whereby the number of components can be reduced. As a result, the assembly process can be reduced. In addition, the weight of the vehicle 12 can be reduced, and the fuel efficiency can be improved.

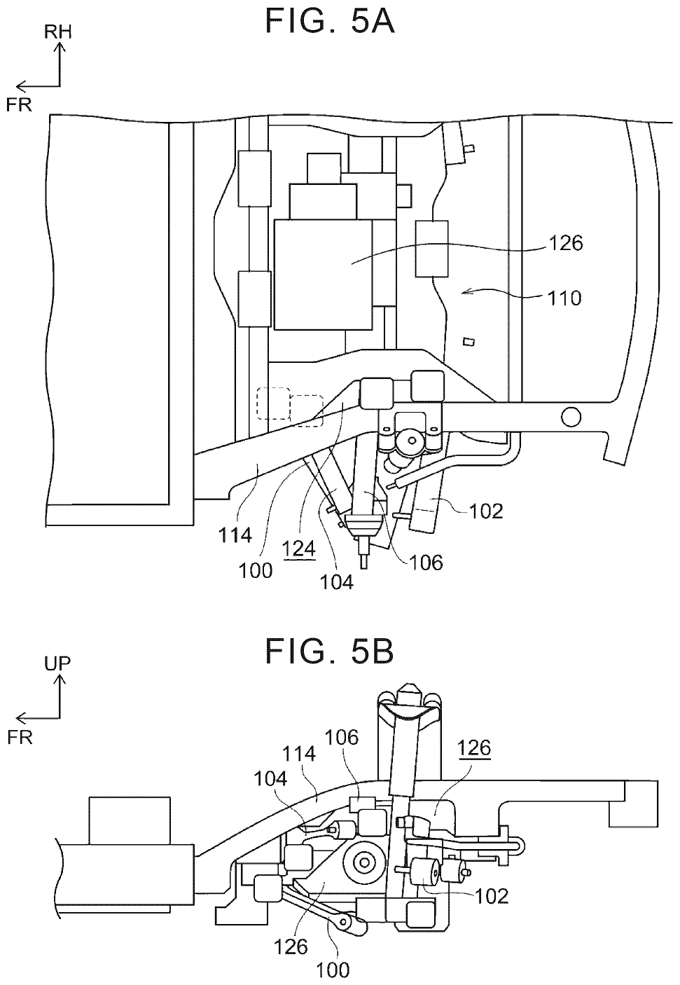

As a comparative example, as shown in FIG. 4, in the vehicle 120 provided with the suspension member 110, the suspension member 110 is attached to the rear side members 112 and 114. Therefore, in order to prevent the rear side members 112 and 114 and the suspension member 110 from interfering with each other, the gaps 124 and 126 need to be provided as shown in FIGS. 5A and 5B.

On the other hand, as shown in FIG. 1, in the present embodiment, there is no suspension member. Therefore, there is no need to provide the gap, and in the rear side members 36 and 38, the dimensions in the vehicle widthwise direction and the vehicle vertical direction can be increased correspondingly as shown in FIGS. 2A and 2B.

Accordingly, the rigidity of the rear side members 36 and 38 can be improved, and as a result, the rigidity of the rear body 50 can be improved, and the steering stability can be improved when the vehicle 12 is traveling.

Further, in the present embodiment, the rear side members 36 and 38 are connected by the cross members 46 and 48, and are integrally molded by casting using an aluminum alloy, a magnesium alloy, or the like as a material. Therefore, the rear body 50 can have high rigidity.

Furthermore, by improving the rigidity of the rear side members 36 and 38, during rear projection of the vehicle 12, it is possible to suppress the bending deformation of the rear side members 36 and 38.

Further, as a comparative example, a gap formed between the rear side members 112 and 114 shown in FIG. 4 and the suspension member 110 is not required in the present embodiment. As a result, as shown in FIG. 1, it is possible to sufficiently secure the mounting space of the drive motor 78, thereby improving workability. Furthermore, in the present embodiment, since there is no suspension member, it is not necessary to attach the suspension member to the rear side members 36 and 38, and the number of assembling steps is reduced accordingly.

As a comparative example, as shown in FIG. 3A, a cushioning member 122 such as a bushing is provided between the suspension arm 108 and the suspension member 110. A cushioning member 128 is provided between the suspension member 110 and the rear side members 112 and 114. Thus, the comparative example has a so-called double vibration isolation function.

In contrast, in the present embodiment, the suspension member is integrated with the rear body 50 as shown in FIG. 3B. Therefore, the cushioning member between the suspension member and the rear side members 36 and 38 is unnecessary, and the number of components can be reduced accordingly. In the present embodiment, a so-called single vibration isolator that serves as the cushioning member 77 between the rear body 50 and the suspension arm 75 is provided, but NV performance can be satisfied by the rigid structure.

Mounting of the drive motor 78 will be described. In the present embodiment, as shown in FIGS. 1 and 2A, the rear side members 36 and 38 are provided with a cross member 46 and a cross member 48. The cross member 46 and the cross member 48 are respectively bridged along the vehicle width direction between the rear side members 36 and 38.

The cross member 48 is disposed on the rear side of the cross member 46 in the vehicle front-rear direction. A front side of the drive motor 78 in the vehicle front-rear direction is attached to the cross member 46, and a rear side of the drive motor 78 in the vehicle front-rear direction is attached to the cross member 48. That is, the drive motor 78 is mounted on the rear side members 36 and 38 via the cross member 46 and the cross member 48.

As shown in FIG. 4, the drive motor 126 is mounted on the suspension member 110, and the suspension member 110 is attached to the rear side members 112 and 114. As compared with this case, in the present embodiment, since the drive motor 78 is only mounted on the cross members 46 and 48 provided in the rear side members 36 and 38 shown in FIG. 1, workability is improved.

Further, as a comparative example, as shown in FIG. 4, when the lower arms 100 and 102 and the upper arms 104 and 106 are connected to the suspension member 110, the upper arms 104 and 106 are connected to the upper side of the suspension member 110.

Since the rear side members 112 and 114 are disposed on the upper side of the suspension member 110, the upper arms 104 and 106 need to avoid interference with the rear side members 112 and 114. Therefore, the upper arm 106 is formed with a curved portion 106A for avoiding interference with the rear side members 112 and 114.

On the other hand, in the present embodiment, since the rear side members 36 and 38 shown in FIG. 1 are formed by casting, the degree of freedom in design is high. In the present embodiment, the upper arms 68 and 70 are connected to the rear side members 36 and 38. Therefore, the upper arms 68 and 70 need only be connected to positions that do not interfere with the rear side members 36 and 38, so that the upper arms 68 and 70 can be formed linearly. Therefore, the rigidity of the upper arms 68 and 70 itself can be improved.

In the present embodiment, the rockers 22 and 24 extend in the vehicle front-rear direction at both end portions of the floor panel 16 in the vehicle width direction. On the other hand, as shown in FIG. 2A, the front portions 52 of the rear side members 36 and 38 are provided with coupling portions 54 and 56, respectively. The front end portions of the rear side members 36 and 38 are coupled to the rear end portions of the rockers 22 and 24 from the outside in the vehicle width direction via the coupling portions 54 and 56, respectively.

Here, a battery 18 is mounted on the center module 34 including the floor panel 16 and the rockers 22 and 24, and the center module 34 is a portion having high rigidity. That is, the front end portions of the rear side members 36 and 38 are coupled to the rear end portions of the center module 34 having high rigidity in a state of being overlapped from the outside in the vehicle width direction.

Therefore, in the present embodiment, the rigidity of the rear side members 36 and 38 can be improved with respect to the yaw direction, and the steering stability can be improved when the vehicle 12 is traveling.

### Supplementary Explanation of Embodiment

In the above-described embodiment, as shown in FIGS. 1 and 2A, the rear side members 36 and 38 and the cross members 46 and 48 are integrally formed by casting using an aluminum alloy, a magnesium alloy, or the like as a material, but the present disclosure is not limited thereto. For example, it may be integrally molded of a plastic such as CFRP.

Further, although the rear side members 36 and 38 and the cross members 46 and 48 are integrally formed, the lower arms 64 and 66 and the upper arms 68 and 70 need only be attached to the rear side members 36 and 38, and therefore, the present disclosure is not limited thereto. For example, each of the rear side members 36, 38 may be formed as a separate body.

Further, in the above-described embodiment, an example in which the side member is applied to the rear side member 36 as the side member as the skeleton member of the vehicle rear portion has been described, but the present disclosure is not limited thereto. Although not shown, it is needless to say that the present disclosure may be applied to a front side member as a skeleton member of a vehicle front portion.

Further, in the above-described embodiment, for example, the cover constituting the upper portion of the battery case 20 constitutes the floor panel 16, but the present disclosure is not limited thereto. For example, the cover and the floor panel 16 may be separately formed.

Further, in the above-described embodiment, as shown in FIG. 1, the rear side members 36 and 38 and the crash boxes 40 and 42 are formed separately, but may be formed integrally.

Furthermore, in the above-described embodiment, the rear side member 36 is provided as a part of the skeleton member of the center module 34, but the rear cross member 28 is not necessarily required depending on the shape of the rear body 50. In this case, the cross member 46 constituting a part of the rear body 50 also serves as the rear cross member 28 of the center module 34. This makes it possible to further reduce the number of components.

Like the rear body 50, although not shown, a side member as a skeleton member may be applied to the front side member. In this case, depending on the shape of the so-called front body, the front cross member 26 of the center module 34 is not necessarily required.

Although an embodiment of the present disclosure has been described above, the present disclosure is not limited to such an embodiment, and the present disclosure may be used in combination with various modifications as appropriate. The present disclosure can be implemented in various forms without departing from the gist of the present disclosure.

### Additional Remarks

The vehicle skeleton member according to the present disclosure may be formed by appropriately combining the following configurations.

### Configuration 1

In the vehicle skeleton structure, a pair of left and right suspension arms are respectively attached to a pair of left and right side members as skeleton members respectively extending in the vehicle front-rear direction at both end portions in the vehicle width direction in the vehicle front portion or the vehicle rear portion.

### Configuration 2

Between the pair of left and right side members, a first cross member and a second cross member are respectively bridged along the vehicle width direction. A front side of a drive motor for driving the vehicle in the vehicle front-rear direction is attached to the first cross member. The second cross member is provided on a rear side of the first cross member in the vehicle front-rear direction, and a rear side of the drive motor in the vehicle front-rear direction is attached to the second cross member.

### Configuration 3

The suspension arm includes a lower arm connected to a wheel, and an upper arm connected to the wheel and disposed on a vehicle upper side of the lower arm.

### Configuration 4

A pair of left and right rockers extending in the vehicle front-rear direction are provided at both end portions of the floor panel in the vehicle width direction. At one end portion of the pair of left and right side members in the vehicle front-rear direction, a pair of left and right coupling portions that are respectively coupled to one end portion of the pair of left and right rockers in the vehicle front-rear direction in a state of being overlapped from the outside in the vehicle width direction are provided.

What is claimed is:

1. A vehicle skeleton structure, wherein a pair of right and left suspension arms is respectively attached to a pair of right and left side members as skeleton members that extend in a vehicle front-rear direction at both end portions in a vehicle width direction at a vehicle front portion or a vehicle rear portion.

2. The vehicle skeleton structure according to claim 1, wherein a first cross member and a second cross member provided on a rear side in the vehicle front-rear direction with respect to the first cross member are bridged along the vehicle width direction between the right and left side members, a front side in the vehicle front-rear direction of a drive motor that drives a vehicle being attached to the first cross member, and a rear side in the vehicle front-rear direction of the drive motor being attached to the second cross member.

3. The vehicle skeleton structure according to claim 1, wherein the suspension arms are each configured to include:
a lower arm connected to a wheel; and
an upper arm connected to the wheel and disposed on a vehicle upper side of the lower arm.

4. The vehicle skeleton structure according to claim 1, further comprising a pair of right and left rockers that extend in the vehicle front-rear direction at both end portions in the vehicle width direction of a floor panel, wherein a pair of right and left coupling portions is provided at one end portion in the vehicle front-rear direction of the right and left side members, the right and left coupling portions being respectively coupled to one end portion in the vehicle front-rear direction of the right and left rockers in an overlapping state from an outer side in the vehicle width direction.
